(19) United States
(12) Patent Application Publication
(10) Pub. No.: US 2022/0394392 A1
(43) Pub. Date: Dec. 8, 2022

(54) PICKUP SENSOR AND BONE-CONDUCTION SPEAKER

(71) Applicants: BOCO INC., Tokyo (JP); GOLDENDANCE CO., LTD., Osaka (JP)

(72) Inventors: Hidenori Nakatani, Tokyo (JP); Hataaki Sha, Tokyo (JP)

(21) Appl. No.: 17/642,858

(22) PCT Filed: May 21, 2020
(86) PCT No.: PCT/JP2020/020039

§ 371 Date: Mar. 14, 2022

(30) Foreign Application Priority Data
Sep. 18, 2019 (JP) 2019-169427

(51) Int. Cl. H04R 9/04; H04R 7/02; H04R 9/08; H04R 9/06; H04R 1/10

(52) U.S. Cl. CPC H04R 9/046; H04R 7/02; H04R 9/08; H04R 9/06; H04R 1/1091; H04R 2460/13

(57) ABSTRACT

According to the present invention, a diaphragm is disposed on a yoke. A recess is formed in the upper surface of the diaphragm. A first metal plate is disposed in the recess. A permanent magnet is disposed on the approximate center of the first metal plate. A second metal plate is disposed on the permanent magnet. The sizes of the first metal plate and the second metal plate are greater than that of the permanent magnet. That is, with respect to the permanent magnet, the first metal plate and the second metal plate are disposed so as to protrude outward beyond the permanent magnet in the longitudinal direction.

### TECHNICAL FIELD OF THE INVENTION

The present invention relates to a pickup sensor and a bone-conduction speaker that can detect vibration efficiently.

### BACKGROUND OF THE INVENTION

Pickup sensors have been conventionally used for measurement of vibrations of some structural bodies. Among various types of pickup sensors, acceleration sensors using piezoelectric elements having excellent sensitivity are widely used.

As such the acceleration sensor, for example, Japanese Unexamined Patent Application Publication No. 2015-145850 (JP-A-2015-145850) proposed an acceleration sensor including a sensor portion including a sensor element for detecting acceleration and a flexible member for fixing the sensor element, and a circuit board for processing output signals from the sensor element, in which the sensor portion and the circuit board are disposed in layers being apart from each other.

Such the acceleration sensor, however, has extremely high sensitivity for detecting micro vibrations. For example, a common sensor portion is configured with electrodes sandwiching a thin sheet of a piezoelectric element, and the sensor portion generally has a weight of less than 1g. Conventional acceleration sensors can detect micro vibrations because of such lightweight sensor portions.

However, in addition to detecting vibrations targeted for measurements, such the conventional pickup sensors are also likely to be affected by surrounding air vibration. For example, when used in a noisy place, the conventional pickup sensor detects air vibration (noise) in addition to vibrations of a structural body targeted for measurements. Thus, accurate measurement is not always possible.

The inventors of the present invention have found out that it is possible to efficiently detect only the vibrations to be inspected by using a bone-conduction speaker as a pickup sensor. In general, a bone-conduction speaker converts electric signals into vibrations and transmits the vibrations directly to bones so that a hearer can hear sounds without the help of air vibrations. Such the bone-conduction speaker can also transmit vibrations to an object to be vibrated other than bones and make the entire object function as a speaker.

The inventors have employed such technology in an opposite way: the inventors have found out that it is possible to detect vibrations by making a bone-conduction speaker come into contact with a vibration target to obtain vibrations and convert the vibrations into electric signals. The inventors also have found out that, at this time, the bone-conduction speaker can efficiently detect only the vibrations of the targeted object without picking up surrounding air vibrations (sounds).

An ordinary bone-conduction speaker hardly vibrates the air and emits sounds unless a vibrating portion thereof is in contact with an object. That is, a bone-conduction speaker never emits vibrations into the air as sounds unless the bone-conduction speaker is in contact with an object to be vibrated.

Using such property in an opposite way, when the bone-conduction speaker is used as a pickup sensor, the bone-conduction speaker hardly picks up surrounding air vibrations and thus the bone-conduction speaker hardly converts air vibrations into electric signals. Thus, even if the pickup sensor is installed onto a structural body that is disposed in a noisy place, the pickup sensor can detect only mechanical vibrations of the targeted object without being affected by the surrounding noise.

As such the bone-conduction speaker, Japanese Unexamined Patent Application Publication No. 2007-74693 (JP-A-2007-74693) proposed a compact bone-conduction speaker including a yoke formed with an extension portion, a voice coil and a center magnetic pole formed on the yoke, a diaphragm attached with an iron piece, the diaphragm being fixed on an upper part of the voice coil and the center magnetic pole, and a permanent magnet attached to an upper part of the iron piece, for example.

Unfortunately, high sensitivity is not so expected for the conventional bone-conduction speaker since the conventional bone-conduction speaker is only for transmission of vibrations to bones etc. for recognition of sounds. However, to be used as a pickup sensor to detect vibrations, it is expected to have more delicate sensitivity to a certain extent. That is, although extremely high sensitivity as high as that of a conventional piezoelectric sensor is unnecessary, sensitivity that is higher than that of the conventional bone-conduction speaker is expected.

To improve sensitivity of the bone-conduction speaker, there is a method, for example, in which a magnetic field of an inner magnet is increased: this can increase electromotive force due to a change of the magnetic field so that small vibrations can be picked up as electric signals. However, increasing the size of the magnet inside the bone-conduction speaker may lead to an increase in size of the device itself as well as an excess magnetic force of the magnet. Because of the configuration, this may cause a diaphragm and a coil to attract each other. As a result, it is difficult for the diaphragm to vibrate and the sensitivity may be deteriorated. Thus, a bone-conduction speaker type pickup sensor having higher sensitivity without an increase in size of the magnet has been awaited.

### SUMMARY OF THE DISCLOSURE

The present invention was made in response to the above issues, and it is an object of the present invention to provide a bone-conduction speaker type pickup sensor and a bone-conduction speaker that are small in size and have excellent sensitivity.

To achieve the above object, a first aspect of the present invention is a pickup sensor including a yoke having a center magnetic pole, a coli that is disposed around the center magnetic pole, a diaphragm that is disposed on an upper part of the coil and the center magnetic pole, a first metal plate that is formed of a magnetic body and is fixed on an upper part of the diaphragm, a permanent magnet that is disposed on an upper part of the first metal plate, and a second metal plate that is formed of a magnetic body and is disposed on an upper part of the permanent magnet. The first metal plate and the second metal plate are larger in size than the permanent magnet.

A rising portion rising upward may be formed at each end portion of the yoke, the each end portion of the yoke being a protruding portion protruding from the coil.

A longitudinal direction of the first metal plate and a longitudinal direction of the second metal plate may intersect with each other at approximately right angles.

The pickup sensor according to the first aspect of the present invention is a bone-conduction speaker type pickup sensor, and thus the pickup sensor is not easily affected by surrounding noise and can efficiently detect only vibrations of a targeted object. For this reason, the pickup sensor can be used with high sensitivity in noisy places.

In particular, with the second metal plate being installed, it is possible to extend the magnetic field without changing the size of the magnet, and this allows the pickup sensor to detect vibrations with further higher sensitivity. Thus, the pickup sensor according to the first aspect of the present invention can detect smaller micro vibrations compared to a conventional bone-conduction speaker.

Also, forming the rising portion at each end portion of the yoke forms the magnetic field from a center portion of the coil through the rising portion. This can more efficiently convert vibrations of the diaphragm into electromagnetic vibrations of the coil.

Also, the longitudinal directions of the first and the second metal plates intersect with each other at approximately right angles, and this can more efficiently extend the magnetic field.

A second aspect of the present invention is a bone-conduction speaker including a yoke having a center magnetic pole, a coli that is disposed around the center magnetic pole, a diaphragm that is disposed on an upper part of the coil and the center magnetic pole, a first metal plate that is formed of a magnetic body and is fixed on an upper part of the diaphragm, a permanent magnet that is disposed on an upper part of the first metal plate, and a second metal plate that is formed of a magnetic body and is disposed on an upper part of the permanent magnet. The first metal plate and the second metal plate are larger in size than the permanent magnet.

According to the second aspect of the present invention, the bone-conduction speaker that can generate clearer sounds can be obtained.

The present invention can provide a bone-conduction speaker type pickup sensor and a bone-conduction speaker that are small in size and have excellent sensitivity.

### BRIEF DESCRIPTION OF DRAWINGS

FIG. 1 is an exploded perspective view of a pickup sensor 1.

FIG. 2 is a plan view of the pickup sensor 1.

FIG. 3 is a cross-sectional view of the pickup sensor 1 taken along A-A line in FIG. 2.

FIG. 4 is a cross-sectional view of the pickup sensor 1 taken along B-B line in FIG. 2.

FIG. 5A is a plan view of a pickup sensor 1a.

FIG. 5B is a cross-sectional view of the pickup sensor 1a.

FIG. 6 is a cross-sectional view of a pickup sensor 1b.

FIG. 7 is a view illustrating a noise reduction system 40.

FIG. 8 is a view illustrating a transceiver 50.

FIG. 9 is a view illustrating an evaluating device 60.

### DETAILED DESCRIPTION

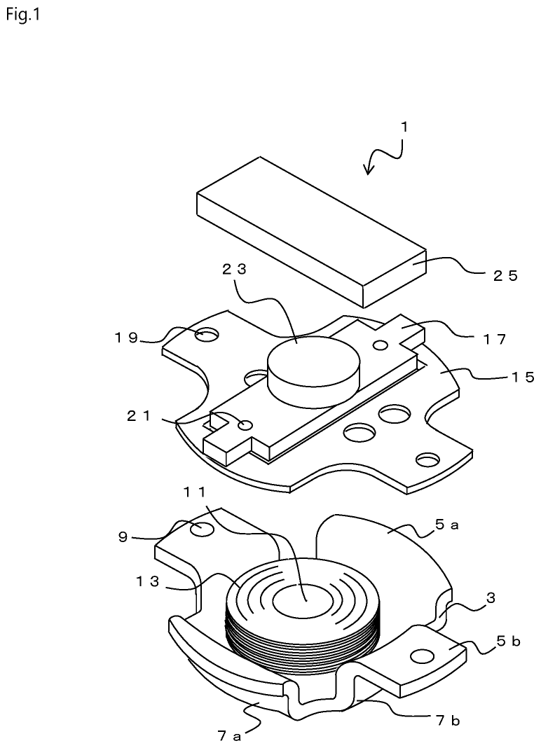

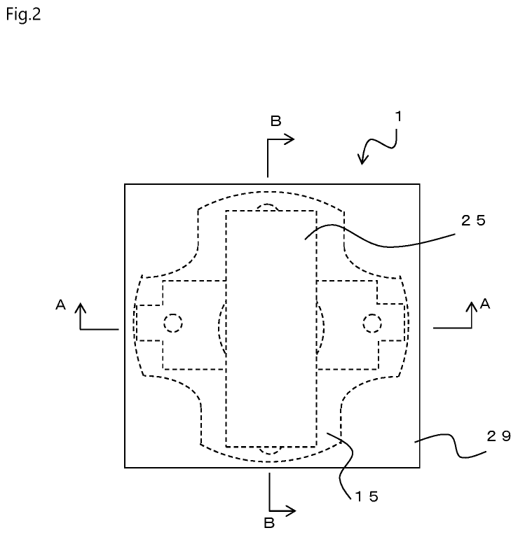

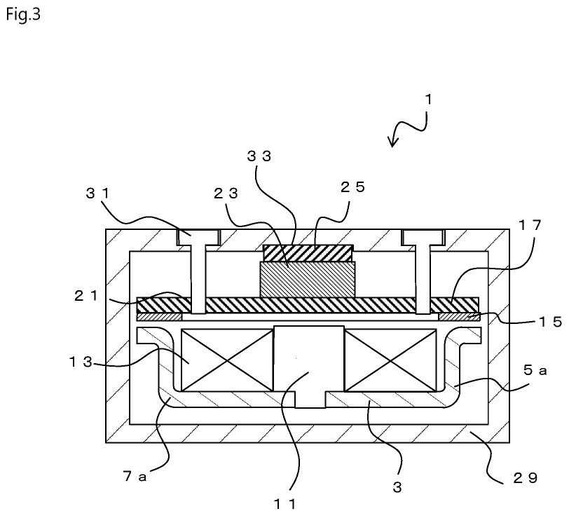

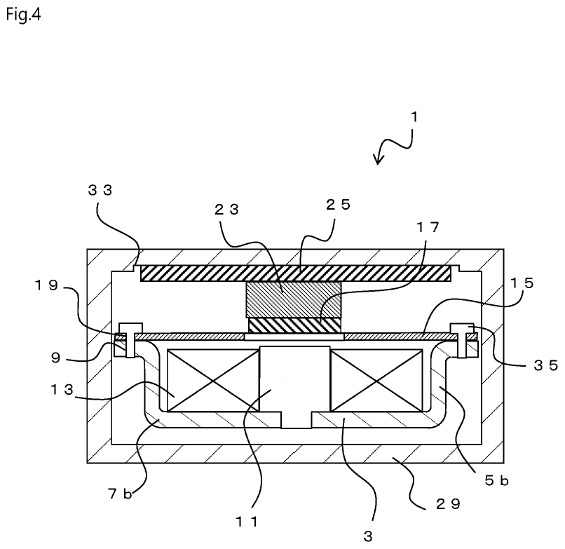

Hereinafter, some embodiments of the present invention will be described with reference to the accompanying drawings. FIG. 1 is an exploded perspective view of a pickup sensor 1according to an embodiment of the present invention. FIG. 2 is a plan view of the pickup sensor 1. FIG. 3 is a cross-sectional view taken along A-A line in FIG. 2, and FIG. 4 is a cross-sectional view taken along B-B line in FIG. 2. An illustration of a housing is omitted in FIG. 1. Although a housing 29 is illustrated as a unified body in FIG. 3 and FIG. 4, the housing may be configured as a box body with an open upper part and a lid portion that covers the box body. Also, illustrations of wirings etc. are omitted in the drawings hereafter. Also, in the descriptions hereafter, a side of a second metal plate 25 when viewed from a center magnetic pole 11 will be referred to as an “upper part”.

The pickup sensor 1 mainly includes a yoke 3, the center magnetic pole 11, a coil 13, a diaphragm 15, a first metal plate 17, a permanent magnet 23, the second metal plate 25, and so on. The yoke 3 and so on are accommodated inside the housing 29.

The center magnetic pole 11 standing upward is disposed at a substantially center portion of the yoke 3. The coil 13 is provided around the center magnetic pole 11.

The yoke 3 has protruding portions 7a and 7b at both end portions thereof in directions intersecting with each other at right angles. That is, the yoke 3 has the protruding portions 7a and 7b formed in four directions. A pair of the facing protruding portions 7a are formed with rising portions 5a rising upward. Also, a pair of the protruding portions 7b facing in a direction intersecting at right angles with the protruding portions 7a are formed with rising portions 5b rising upward. The rising portion 5b is formed so that a height of an upper surface of the rising portion 5b is higher than the coil 13 and the center magnetic pole 11. A screw hole 9 is formed on the upper surface of the rising portion 5b. The rising portions 5a are not always necessary.

The diaphragm 15 is disposed on an upper part of the yoke 3. The diaphragm 15 has an approximately a cross shape in a plan view, which is approximately similar to the shape of the yoke 3. That is, the diaphragm 15 is also in a shape with protruding portions in four directions. A hole 19 is formed on each of a pair of the facing protruding portions of the diaphragm 15.

As shown in FIG. 4, the hole 19 is placed over the screw hole 9 of the yoke 3 (the rising portion 5b) and a screw 35 fixes the diaphragm 15 to the yoke 3. The diaphragm 15 is a thin metal plate, for example, part of which is formed with a through hole. The first metal plate 17 is disposed on an upper part of the through hole of the diaphragm 15. The first metal plate 17 is disposed striding across both sides of the through hole of the diaphragm 15, and both ends of the first metal plate 17 are fixed to the diaphragm 15 by spot welding, for example. The first metal plate 17 is approximately rectangular shaped and disposed in such a way that a longitudinal direction thereof intersects at right angles with a forming direction of the holes 19. That is, the first metal plate 17 is disposed so as to stride across an upper part of the protruding portions 7a of the yoke 3.

The permanent magnet 23 is disposed on an upper part of an approximately center of the first metal plate 17. That is, as shown in FIG. 3 and FIG. 4, the permanent magnet 23 is disposed at a part corresponding to the center magnetic pole 11. The shape of the permanent magnet 23 is not restricted to a circular shape and may be any shape such as a square.

The second metal plate 25 is disposed on an upper part of the permanent magnet 23. The first metal plate 17 and the second metal plate 25 are approximately rectangular shaped, and the first metal plate 17 and the second metal plate 25 are larger in size than the permanent magnet 23. That is, with respect to the permanent magnet 23, the first metal plate 17 and the second metal plate 25 are disposed so as to protrude outward beyond the permanent magnet 23 in longitudinal directions of the first metal plate 17 and the second metal plate 25, respectively. The first metal plate 17 and the second metal plate 25 are disposed in such a direction that the longitudinal direction of the first metal plate 17 intersects at approximately right angles with the longitudinal direction of the second metal plate 25. That is, the first metal plate 17 is disposed striding over the upper part of the protruding portions 7a on both ends of the yoke 3, and the second metal plate 25 is disposed striding over the upper part of the protruding portions 7b on both ends of the yoke 3.

A screw hole 21 is formed in proximity of each end portion of the first metal plate 17. As shown in FIG. 3, when being accommodated in the housing 29, the first metal plate 17 is fixed to the housing 29 with a screw 31. The yoke 3, the first metal plate 17, and the second metal plate 25 are all magnetic bodies, shapes of which are not limited to the illustrations.

The second metal plate 25 is in contact with an inner surface of the housing 29. At this time, a recess 33 corresponding to a shape of the second metal plate 25 is formed on the inner surface of the housing 29. The recess 33 is formed at a part corresponding to the second metal plate 25, and the second metal plate 25 is fitted inside the recess 33, coming into contact with an inner surface of the recess 33. This fixes a direction of the second metal plate 25.

At this time, as shown in FIG. 3 and FIG. 4, there is a clearance formed between a lower surface of the diaphragm 15 and upper surfaces of the center magnetic pole 11 and the coil 13. There is also a clearance between the rising portions 5a and the diaphragm 15. As above, the diaphragm 15 can vibrate without being in contact with, except for fixing portions of the screws 35 at the rising portions 5b, the yoke 3, the center magnetic pole 11, and the coil 13.

As shown in FIG. 3 and FIG. 4, since the first metal plate 17 and the second metal plate 25 protrude in different directions on both sides of the permanent magnet 23, magnetic lines of the permanent magnet 23 run from the first metal plate 17 and the second metal plate 25, passing through the protruding portions 7a and 7b of the yoke 3 and the center magnetic pole 11, and back to the permanent magnet 23 to form a magnetic field. In such a state, because of magnetic force of the magnetic field, the first metal plate 17 is always attracted to the center magnetic pole 11.

When vibrations are added in such the state, a distance between the diaphragm 15 and the coil 13 changes, which changes the surrounding magnetic field. This then changes magnetic force passing through the center magnetic pole 11. The change added to the coil 13 generates electromotive force, and an electric current flows in the coil 13. As above, the vibrations can be detected by converting the vibrations into electric signals.

Here, the inventors have found out that it is possible to improve sensitivity of the pickup sensor, without changing the magnetic force, by extending a range of the magnetic field. That is, the inventors found out that, by disposing the second metal plate 25, the magnetic field can be further extended from the upper part of the permanent magnet 23 to the protruding portions 7b (the rising portions 5b) of the yoke 3, and this can improve sensitivity of the pickup sensor.

For example, without the second metal plate 25 being disposed, although the magnetic field is generated between the first metal plate 17 (or the permanent magnet 23) and the protruding portions 7a of the yoke 3, it is impossible to extend the magnetic field toward the protruding portions 7b. In contrast, with the second metal plate 25 being disposed, in addition to the first metal plate 17 (or the permanent magnet 23), the magnetic field is generated between the protruding portions 7b of the yoke 3 and end potions of the second metal plate 25, which are parts distanced away from the protruding portions 7b in a height direction. As a result, when compared to a case without the second metal plate 25, the magnetic field can be further extended and much smaller vibrations can change the magnetic field. Thus, it can be considered that the second metal plate 25 can improve the sensitivity.

As above, according to the present embodiment, a medium that can be used as a bone-conduction speaker is used as a pickup sensor, and thus it is possible to obtain a pickup sensor that is unlikely to be affected by surrounding noise. At this time, with the second metal plate 25 being disposed on the upper part of the permanent magnet 23 (on an opposite side of the center magnetic pole 11), the magnetic field can be extended and the sensitivity can be improved.

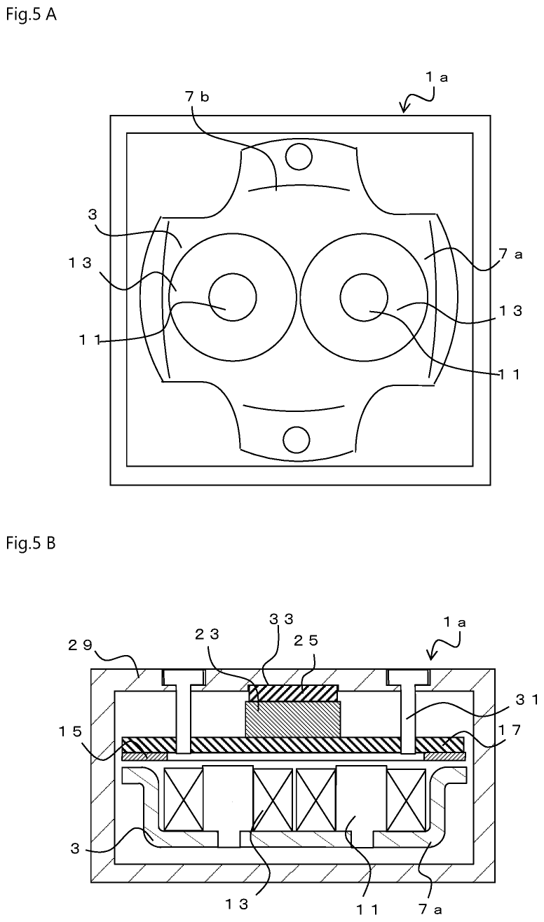

Next, a second embodiment of the present invention will be described. FIG. 5A is a plan view of the yoke 3 etc. of a pickup sensor 1a according to the second embodiment of the present invention (a perspective view of the diaphragm 15 etc.), and FIG. 5B is a cross-sectional view of the pickup sensor 1a (corresponding to FIG. 3). In the descriptions hereafter, structures having the same functions as in the pickup sensor 1 will have the same notations as in FIG. 1 through FIG. 4 and redundant descriptions will be omitted.

The pickup sensor 1a is configured approximately similarly to the pickup sensor 1 except that the pickup sensor 1a includes a pair of the center magnetic poles 11 and a pair of the coils 13, which are arranged side by side.

The pair of the center magnetic poles 11 are arranged side by side in a direction of the protruding portions 7a of the yoke 3, and the coil 13 is disposed on an outer periphery of each of the center magnetic poles 11. The first metal plate 17 is disposed on the upper part of the yoke 3, striding over the pair of the coils 13.

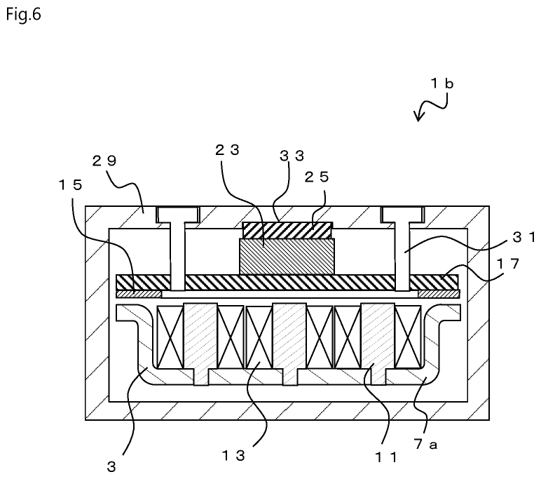

The number of the center magnetic poles 11 and the coils 13 arranged side by side is not restricted to two. For example, as in a pickup sensor 1b shown in FIG. 6, there may be three each of the center magnetic poles 11 and the coils 13 arranged side by side. Also, the center magnetic poles 11 and the coils 13 may be arranged in a direction perpendicular to the longitudinal direction of the first metal plate 17.

According to the second embodiment, the same effects as in the first embodiment can be obtained. As above, a plurality of the center magnetic poles 11 and the coils 13 may be disposed on the yoke 3.

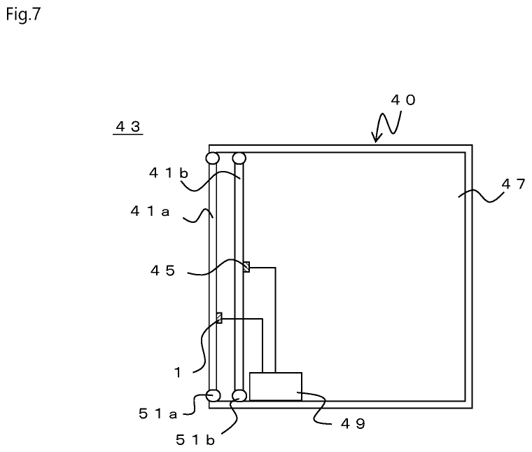

Next, a method for using the above-mentioned pickup sensors will be described. FIG. 7 is a view illustrating a noise reduction system 40 using the pickup sensor 1. In the descriptions hereafter, examples using the pickup sensor 1 will be illustrated. However, the pickup sensors 1a and 1b are also applicable.

The noise reduction system 40 mainly includes a structural body 41a, a structural body 41b, the pickup sensor 1, a bone-conduction speaker 45, an amplifier 49, and so on. In this example, the noise reduction system 40 is used in a case where a space 47 is a room and a noise generating part 43 is another adjacent space (such as a street outside). The noise generating part 43 is not limited to a source of noise itself but may include all spaces and places where the noise is generated.

The space 47 and the noise generating part 43 are separated by the structural bodies 41a and 41b. As shown in the drawings, the structural body 41a and the structural body 41b are individual bodies, and the structural body 41b is disposed on a side closer to the space 47 parallel to and away from the structural body 41a. The structural bodies 41a and 41b are in approximately the same size and may be walls of the room, for example. Alternatively, the structural body 41a may be a wall portion of the room and the structural body 41b may be a simple wall or a partition wall disposed inside the wall portion of the space 47. Also, if the wall of the room is a hollow wall, the structural body 41a may be an exterior wall portion and the structural body 41b may be an interior wall portion. Also, the structural bodies 41a and 41b may form a double-pane window. That is, the structural bodies 41a and 41b may be in any forms that can separate, at least partly, the space 47 from the noise generating part 43, and may include vertical separating parts such as a ceiling or a floor, and a structure of a part of a wall.

The structural bodies 41a and 41b are joined to other structural bodies covering the space 47 (structural bodies configuring walls, ceilings, and floors) via isolating portions 51a and 51b, respectively. The isolating portions 51a and 51b are damping members or elastic bodies, for example, that suppress transmission of vibrations of the structural bodies 41a and 41b to the other structural bodies.

The pickup sensor 1 is installed onto the structural body 41a. As mentioned above, the pickup sensor 1 receives vibrations of the structural body 41a and converts the vibrations into electric signals.

The pickup sensor 1 is connected to the amplifier 49. The amplifier 49 includes an amplifier circuit that can adjust a phase of vibration information received by the pickup sensor 1. The amplifier circuit may be a digital circuit for a faster processing time, or may be an analog circuit. The amplifier 49 inverts the phase of the vibrations received by the pickup sensor 1 and amplifies the vibrations to generate electric signals.

The bone-conduction speaker 45 is connected to the amplifier 49. The electric signals output from the amplifier 49 are transmitted to the bone-conduction speaker 45, thereby vibrating the bone-conduction speaker 45. The bone-conduction speaker 45 is installed on the structural body 41b. Thus, the bone-conduction speaker 45 can vibrate the entire structural body 41b. The bone-conduction speaker 45 has the same structure as the pickup sensor 1 and allows the entire structural body 41b to function as a speaker.

The amplifier 49 can adjust or filter an amount of amplification of the electric signals or a lag time of the vibrations etc., if necessary, according to a distance between or materials of the structural bodies 41a and 41b. For example, it is preferable that the amplifier 49 vibrates the structural body 41b with a time difference corresponding to the distance between the structural body 41a and the structural body 41b.

Next, functions of the noise reduction system 40 will be described. Noise generated in the noise generating part 43 enters into the space 47 through the walls of structural bodies 41a and 41b, etc. At this time, vibrations of a vibration source in the noise generating part 43 are transmitted to the structural bodies 41a and 41b in a form of air vibrations, and vibrations of the structural bodies 41a and 41b vibrate the air inside the room 47.

The noise reduction system 40 then lets the pickup sensor 1 receive the vibrations of the structural body 41a caused by sounds from the outside of the room, lets the amplifier 49 invert the phase, and vibrates the bone-conduction speaker 45. At this time, the vibrations of the structural body 41b by the bone-conduction speaker 45 cancels out the vibrations of the structural body 41b transmitted by air vibration from the structural body 41a, and this can suppress the vibrations of the structural body 41b. Thus, it is possible to reduce the noise entering into the space 47 from outside of the room through the structural bodies 41a and 41b.

As above, the noise reduction system 40 can suppress the noise generated in the noise generating part 43 from entering into the space 47. At this time, compared to a conventional noise cancelling case in which inverted air vibrations from a speaker cancels out the received air vibrations of the noise, the noise reduction system 40 vibrates the structure body itself where the noise enters, and thus efficient noise reduction for the entire space 47 is possible.

Also, the isolating portion 51a of the structural body 41a suppresses transmission of the vibrations to the other structural bodies. Thus, it is possible to suppress transmission of the vibrations of the structural body 41a to the other walls or the like of the room. Similarly, the isolating portion 51b of the structural body 41b suppresses transmission of the vibrations to the other structural bodies. Thus, the isolating portion 51b also suppresses transmission of the vibrations generated by the bone-conduction speaker 45 to the other walls or the like of the room.

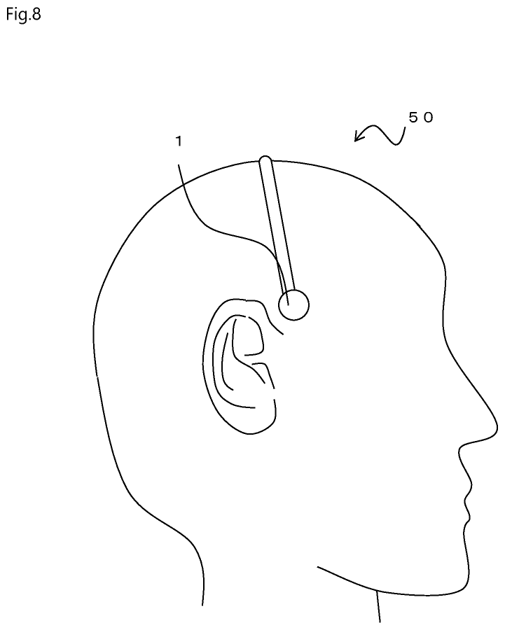

Next, another method for using the pickup sensors will be described. FIG. 8 is a view illustrating a transceiver 50. The transceiver 50 includes the pickup sensor 1 being fixed to a headset, for example, which comes into contact with a part of bones of a user's face. When the user speaks in such the state, the pickup sensor 1 detects vibrations of the bones and converts the vibrations into electric signals. That is, the pickup sensor 1 can be used as a microphone. Also, the user may change a function of the pickup sensor 1 to be used as a speaker. That is, the pickup sensor 1 can be used as a bone-conduction speaker.

In more detail, when the user speaks wearing the pickup sensor 1, the pickup sensor 1 can detect the vibrations of the bones. The obtained electric signals are transmitted through a wireless transmitter, of which illustration is omitted, to a receiver's wireless transmitter as voice sound information. The receiver can hear the voice sound through face bones by making the similarly worn pickup sensor 1 function as a bone-conduction speaker. As above, the pickup sensor 1 can be used for conversation by switching between the microphone function (receiving vibrations) and the speaker function (generating vibrations).

According to the transceiver 50, even in a noisy place, the pickup sensor 1 only detects the vibrations of face bones that are in contact with the pickup sensor 1, and this can make sure that the transceiver 50 detects voice sounds without being affected by the surrounding noise, allowing the user to hear only the voice sounds. Thus, compared to a transceiver using a conventional voice-sound microphone, the transceiver 50 can transmit and receive only clear voice sound even in a noisy place.

The methods for using the pickup sensor 1 are not limited to the examples mentioned above. For example, the pickup sensor 1 can be used as a pickup sensor for non-destructive inspections on plumbing or concrete structures. Also, continuous detections on factory facilities or vehicles such as automobiles, for example, enable to detect malfunctions in early stages. At this time, the pickup sensor according to the present invention is hardly affected by sounds due to surrounding air vibrations, and thus, compared to methods using conventional acceleration sensors, the pickup sensor according to the present invention can more efficiently detect vibrations that are targeted for inspections even in a noisy place.

### WORKING EXAMPLES

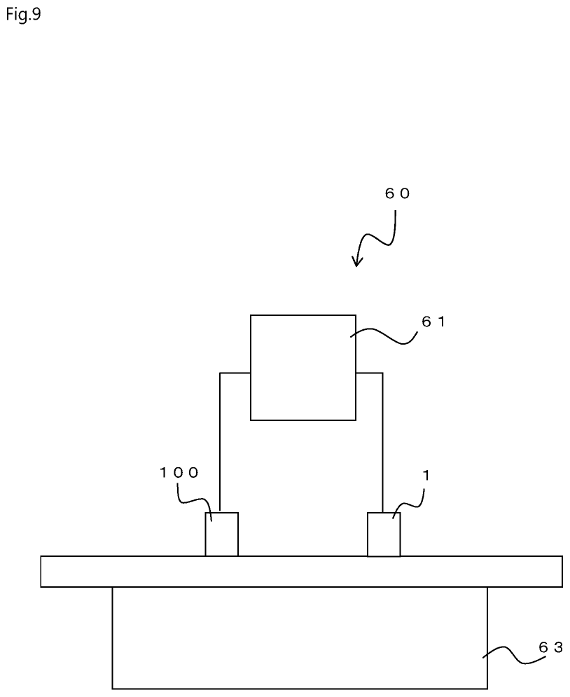

Sensitivities of a conventional pickup sensor and the pickup sensor according to the present invention are compared. FIG. 9 is a schematic view showing an evaluating device 60. A pickup sensor 100 and the pickup sensor 1 are disposed on a vibrating body that is vibrated by a vibration generator 63, and an analyzer 61 detects waveforms to be evaluated.

Vibrations generated by the vibration generator 63 are varied from 20 Hz to 20 kHz. Unlike the pickup sensor 1, the pickup sensor 100 is configured without the second metal plate, and a bone-conduction speaker approximately configured as disclosed in Japanese Unexamined Patent Application Publication No. 2007-74693 (JP-A-2007-74693) is used as the pickup sensor 100.

The result shows that sound pressure detected by the pickup sensor 1 is approximately 30% greater than sound pressure detected by the pickup sensor 100.

Similarly, with the vibration generator 63 being stopped, the pickup sensors 1 and 100 are functioned as bone-conduction speakers and a piezoelectric sensor measures vibrations from the bone-conduction speakers. The result shows that, compared to a case in which the pickup sensor 100 is used, an improvement of 3dB or greater is confirmed when the pickup sensor 1 is used. Also, there is a slight improvement in clarity of sound voice. Although there are differences among individuals, consonants are particularly easy to hear. As above, the pickup sensor according to the present invention can emit clearer sound voice when used as a bone-conduction speaker, which is an original usage thereof.

This is because, as mentioned above, the second metal plate 25 is disposed on the upper part of the permanent magnet 23 so as to protrude outward beyond the permanent magnet 23, and this allows the magnetic field to extend, resulting in rise of the sensitivities and the like.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

What is claimed is:

1. A pickup sensor comprising:
a yoke having a center magnetic pole;
a coli that is disposed around the center magnetic pole;
a diaphragm that is disposed on an upper part of the coil and the center magnetic pole;
a first metal plate that is formed of a magnetic body and is fixed on an upper part of the diaphragm;
a permanent magnet that is disposed on an upper part of the first metal plate; and
a second metal plate that is formed of a magnetic body and is disposed on an upper part of the permanent magnet, wherein
the first metal plate and the second metal plate are larger in size than the permanent magnet.

2. The pickup sensor according to claim 1, wherein
a rising portion rising upward is formed at each end portion of the yoke, the each end portion of the yoke being a protruding portion of the coil.

3. The pickup sensor according to claim 1, wherein
a longitudinal direction of the first metal plate and a longitudinal direction of the second metal plate intersect with each other at approximately right angles.

4. A bone-conduction speaker comprising:
a yoke having a center magnetic pole;
a coli that is disposed around the center magnetic pole;
a diaphragm that is disposed on an upper part of the coil and the center magnetic pole;
a first metal plate that is formed of a magnetic body and is fixed on an upper part of the diaphragm;
a permanent magnet that is disposed on an upper part of the first metal plate; and
a second metal plate that is formed of a magnetic body and is disposed on an upper part of the permanent magnet, wherein
the first metal plate and the second metal plate are larger in size than the permanent magnet.
